(19) United States
(12) Patent Application Publication
(10) Pub. No.: US 2009/0251400 A1
(43) Pub. Date: Oct. 8, 2009

(54) LCD DISPLAY METHOD

(75) Inventors: Weidong Liu, Qingdao (CN); Mingsheng Qiao, Qingdao (CN); Liang Ma, Qingdao (CN); Guopeng Huang, Qingdao (CN)

Correspondence Address: KNOBBE MARTENS OLSON & BEAR LLP, 2040 MAIN STREET, FOURTEENTH FLOOR, IRVINE, CA, 92614, US

(73) Assignees: HISENSE BEIGING ELECTRIC CO., LTD., Daxing (CN); HINSENSE GROUP CO., LTD, Laoshan Zone (CN); HISENSE ELECTRIC CO., LTD, Qingdao Economic & Development Zone (CN)

(21) Appl. No.: 12/061,572

(22) Filed: Apr. 2, 2008

(51) Int. Cl. G09G 3/36

(52) U.S. Cl. 345/102

(57) ABSTRACT

The present invention offers a display method, which can adjust the brightness of backlight by the brightness correction of the backlight, thereby not only decreasing the power consumption, but also solving the problem of blinking backlights. Especially, the display method of the present invention comprises: receiving an image signals, calculating the typical brightness of said image signal, calculating the brightness correction of the backlight according to the typical brightness of said image signal and the brightness of the backlight, adjusting the brightness of the backlight according to the brightness correction of the backlight, and adjusting said image signal. The display method of the present invention is correcting the image gray and contrast by applying the algorithm of slow changing of backlight according to the brightness scale of the input image, while adjusting the brightness of the backlight, therefore unchanging or increasing the subjective image effect, preventing the blinking of the backlight and improving the quality of the display.

### BACKGROUND

1. Technical Field

The present invention relates to a display method, specifically to a image display method used in a display device.

2. Background of the Invention

In recent years, the technology of LCD displays has rapidly developed, yet compared with other kinds of display technologies, LCD displays still have problems with contrast and color saturation.

The LCD display screen (LCD) of a LCD display device (such as liquid crystal television) can not light itself, so it needs a backlight. There is a backlight in the back of the LCD, and the LCD device displays or recovers the image by the fine particles, which are uniformly arranged in the screen, “interdicting” and “turning on” the light emitted by the backlight. In the preliminary stage, the backlight works as long as the LCD is switched on, even if the displayed image is completely black. That is, the backlight of a LCD television is always lit. Since transmittance of liquid crystal is very low, the light of the backlight should be strong enough to make the liquid TV bright enough to perfectly display the image. This will not only shorten the lifetime of the backlight of the LCD device, but also cause asthenopia of the viewer. The contrast and color saturation of the displayed image will be decreased if the brightness of the backlight decreases.

The appearance and development of the backlight adjustment technology solves the problem to some extent. The backlight adjustment technology can dynamically adjust the backlight according to the content of the picture, and the detailed implementation is to set the backlight to dynamically lighten the circuit system (generally applying programmable logic device and several hardware devices) and control the backlight and adjust the brightness of the backlight according to the content of the picture. This guarantees the contrast and color saturation of the image and lengthens the lifetime of the backlight.

However, this backlight adjustment technology has some deficiencies. Since this technology adjusts the brightness of the backlight in real time according to the brightness of each frame image, the brightness of backlight will rapidly change when the displayed image changes relatively fast. Therefore the amplitude of change of the brightness of the backlight is relatively large if the brightness of the pre and post frame images are quite different. This can make the human eye feel as if the image is blinking and affect the quality of image. This blinking effect may be seen in any display device which uses a backlight and is not limited to LCD displays.

### SUMMARY OF THE INVENTION

The present invention offers a display method, which adjusts the brightness of backlight by the brightness correction of the backlight and solves the problem of blinking backlight.

In one embodiment, there is a display method comprising receiving an image signal, calculating a typical brightness of said image signal, calculating a brightness correction of the backlight according to the typical brightness of said image signal and a brightness of the backlight, adjusting the brightness of the backlight according to the brightness correction of the backlight, and adjusting said image signal.

If the typical brightness of said image signal is larger than a predetermined reference value, the brightness correction of the backlight is larger than the present brightness of the backlight. If the typical brightness of said image signal is smaller than a predetermined reference value, the brightness correction of the backlight is smaller than the present brightness of the backlight. If the typical brightness of said image signal is zero, the brightness correction of the backlight is zero.

If the typical brightness of said image signal is larger than a predetermined reference value, the brightness correction of the backlight is the present backlight brightness plus a predetermined change value If the typical brightness of said image signal is smaller than said predetermined reference value, the brightness correction of the backlight is the present backlight brightness minus a predetermined change value. The predetermined reference value and the change value can be varied according to a user setting.

The typical brightness may be the weighted average value of the brightness calculated according to the statistical result of the histogram of the brightness of the image. The adjustment for said image signal comprises adjusting the brightness of said image according to the typical brightness of said image. The change value of the brightness of said image may be selected according to the curve of the typical brightness of said image.

In another embodiment, there is a method comprising dividing the backlight into at least two backlight segments, receiving an image signal, dividing said image into at least two image segments according to the backlight segments, calculating the typical brightness of each image segment, calculating the brightness correction of the backlight of each segment according to the typical brightness of each image segment and the present brightness of the corresponding backlight segments, adjusting the brightness of each backlight according to the brightness correction of the backlight of each segment and adjusting said image signal.

If the typical brightness of said image signal of this segment is larger than a predetermined reference value, the brightness correction of the backlight of this segment is larger than the present brightness of the backlight of this segment. If the typical brightness of said image signal of this segment is smaller than said predetermined reference value, the brightness correction of the backlight of this segment is smaller than the present brightness of the backlight of this segment. If the typical brightness of said image signal of this segment is zero, the brightness correction of the backlight of this segment is zero.

If the typical brightness of said image signal of this segment is larger than a predetermined reference value, the brightness correction of the backlight of this segment is the present backlight brightness of this segment plus a predetermined change value. If the typical brightness of said image signal of this segment is smaller than said predetermined reference value, the brightness correction of the backlight of this segment is the present backlight brightness of this segment minus a predetermined change value. The predetermined reference value and the change value can be varied according to the user's setting, and the predetermined reference and change value of each segment can be different.

The typical brightness of at least one segment may be the weighted average value of the brightness calculated according to the statistical result of the histogram of the brightness of the image of this segment. Said image brightness of this segment is adjusted according to the typical brightness of said image of the segment. The change value of the brightness of said image of this segment may be selected according to the curve of the typical brightness of said image of this segment.

The display method of the present invention may correct the image gray and contrast by applying the algorithm of slow changing of backlight according to the brightness scale of the input image, while adjusting the brightness of the backlight, therefore unchanging or increasing the image subjective effect, preventing the blinking of the backlight and improving the quality of the LCD display.

### BRIEF DESCRIPTION OF DRAWINGS

FIG. 1 is a schematic diagram in accordance with a first embodiment applying the LCD method of the present invention.

FIG. 2 shows the method for calculating the value of the brightness correction of the backlight in accordance with the first embodiment.

FIG. 3 shows the method for adjusting the brightness of the image in accordance with the first embodiment.

FIG. 4 is a schematic diagram in accordance with a second embodiment applying the LCD method of the present invention.

### DETAILED DESCRIPTION OF THE EMBODIMENTS

The present invention will be described in further detail with reference to embodiments and the accompanying drawings.

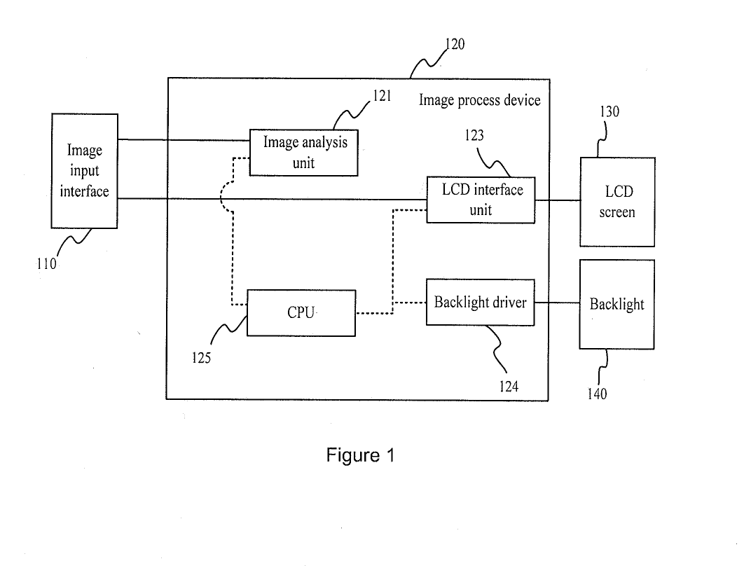

FIG. 1 is a schematic diagram in accordance with the first embodiment applying the LCD method of the present invention. As shown in FIG. 1, the LCD device comprises image input interface 110, image process device 120, LCD screen 130 and backlight 140. The image process device 120 comprises image analysis unit 121, liquid crystal interface unit 123, backlight driver 124 and CPU 125, and the image process device 120 may consist of several separated components or integrate into a chip to become one body.

The image input interface 110 receives image signals and sends them to the image process device 120. The image signals may be either digital signals or analog signals, such as RGB, CVSB or S-video signal. If it is analog, it will firstly be A/D converted by the image input interface 110 to become digital, then be sent to the image process device 120. Here we will take RGB signal for example to illustrate the image processing by the image process device 120.

One channel of RGB signal received by the image process device 120 will be sent to the image analysis unit 121 for analyzing and calculating the typical brightness of the present image. The method for calculating the typical brightness of the image may be performed through many analysis methods. It can analyze the image signal directly in spatial domain or in frequency domain. For example, it can directly calculate the brightness of the image signal via methods such as Fourier transform, Laplace transform, etc., or analyze the spectrum of the image signal via other methods.

Take statistical analysis of a histogram for example. First, the image analysis unit 121 transforms a received frame of RGB signal to YUV formatted digital signal. The object of the image transform is to extract the brightness signal in the RGB signal. This procedure can be replaced by extracting the brightness information of the RGB signal. After the brightness data of the whole image is obtained, the image analysis unit 121 will perform histogram statistics of the brightness data and calculate the weighted average value of the brightness of the present image. This information can be used as the typical brightness of the present image, according to the statistical result of the histogram of the brightness of the present image. After the typical brightness of the image is calculated, the image analysis unit 121 transfers the corresponding data to the CPU 125. For description, the typical brightness of the present image is represented as L.

After it receives the typical brightness of the image from the image analysis unit 121, the CPU 125 calculates the correction value of the present backlight brightness according to the typical brightness of the present image and the present backlight brightness.

The correction value of the present backlight brightness of the present embodiment may be obtained by the method described below.

Suppose that the typical brightness of the present image L=0, then the correction value of the present backlight brightness is also 0. If the typical brightness of the present image L≠0, the present embodiment applies the algorithm of slowly changing the backlight brightness to prevent the blinking of the picture caused by the rapid change of the backlight brightness. If the typical brightness of the present image is relatively high, then it increases the present backlight brightness, and decreases it otherwise.

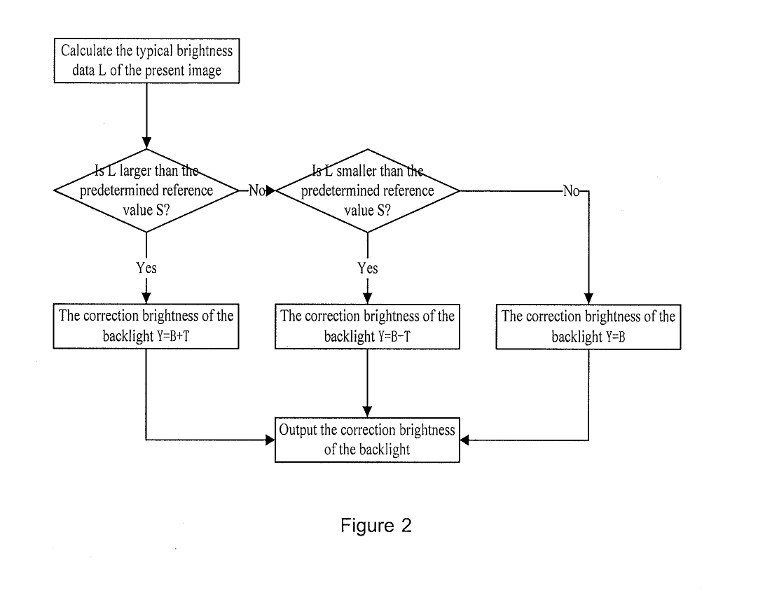

The reference value of the backlight selected by the present embodiment is S=127, and the change value of the backlight is T. Suppose that the present backlight brightness value is B, while the correction value of the present backlight brightness is Y, then the method for calculating the correction value of the present backlight brightness is shown as FIG. 2. In the condition that there is image signal input, if L>S, then Y=B+T; if L<S, then Y=B−T; if L=S, then Y=B. The above algorithm can make the backlight brightness of the LCD dynamically change with the variety of the brightness of the input signal image. This may prevent the blinking of the backlight.

Where S is the reference value of backlight and T is the change value of the backlight, the value of S and T can be changed according to the user's settings. This makes it convenient for a user to adjust the display effect of the LCD device.

After the correction value of the backlight brightness is calculated, the CPU 125 will send the correction value to the backlight driver 124 and the LCD interface unit 123.

According to the correction value of the backlight brightness determined by the CPU 125, the backlight driver 124 generates the driving signal corresponding to the correction value of the backlight brightness for the backlight 140. The driving signal is a PWM (pulse width modulation) signal with certain duty cycle, and the PWM driving signal is the driving current. Since the brightness is determined by the light flux of the RGB-LED and the light flux of the LED has a linear relationship with the current, the brightness is determined by the driving current.

The duty cycle of the above PWM signal can be obtained by calculating the following formula:

r=Y/Y_{MAX}

wherein, r is the duty cycle of the PWM signal, Y_{MAX} is the maximum brightness of the backlight and the general value of Y_{MAX} is 255ₒ

Since the brightness of the backlight is adjusted, the image signal itself should be adjusted correspondingly to properly display the originate image. The LCD interface unit 123 adjusts the image signal itself according to the correction value of the backlight brightness determined by the CPU 125. First, the LCD interface unit 123 adjusts the brightness of the image. From the above process of adjusting the brightness of the backlight, it can be seen that since the correction value of the backlight brightness Y is always less than Y_{MAX}. The brightness of the backlight is generally low. Therefore, the brightness of the image should be adjusted to higher, and the scale of adjustment can be increased correspondingly according to the scale of Y/Y_{MAX}, or maybe some other method, such as adjusting through the method of inquiry list mapping.

Preferably, the LCD interface unit 123 adjusts the brightness of the present image through the following method.

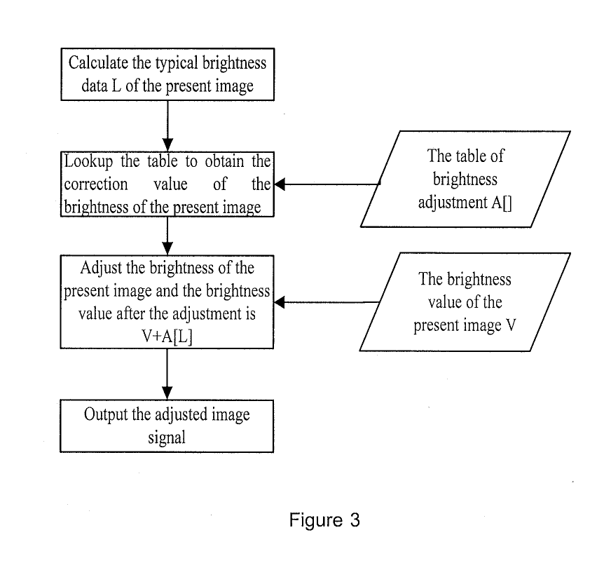

As shown in FIG. 3, the LCD interface unit 123 of the present embodiment dynamically increases the brightness value of the present image according to the typical brightness value L of the present image, which ensures that the effects of the image of the input signal will be not largely changed when the brightness of the backlight decreases. The present embodiment selects a table A[ ] to save the increase value of the brightness of each frame image. In table A[ ], L is used as the parameter to save the change value of the brightness selected according to the numerical curve. Suppose that the brightness value of the present image is V, then the adjusted brightness value is V+A[L].

Table 1 is an example of table A[ ] and comprises 256 numbers which respectively corresponds to the change values of the brightness of the image when the value of L is from 0 to 255. For example, if the typical brightness data of the present image is 50, the look-up result shows that when L=50, the corresponding change value of the brightness of the image is 12, then the brightness of each pixel in the present image is increased by 12.

TABLE 1

0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x12, 0x12, 0x12, 0x12, 0x12, 0x12, 0x12, 0x12, 0x12, 0x12,
0x11, 0x11, 0x10, 0x10, 0x09, 0x09, 0x09, 0x08, 0x08, 0x07,
0x06, 0x05, 0x04, 0x04, 0x03, 0x03, 0x02, 0x02, 0x01, 0x01,
0x02, 0x02, 0x02, 0x02, 0x02, 0x02, 0x02, 0x02, 0x02, 0x02,
0x01, 0x01, 0x01, 0x01, 0x01, 0x01, 0x01, 0x01, 0x01, 0x01,
0x01, 0x01, 0x01, 0x01, 0x01, 0x01, 0x01, 0x01, 0x01, 0x01,
0x01, 0x01, 0x01, 0x01, 0x01, 0x01, 0x01, 0x01, 0x01, 0x01,
0x00, 0x00, 0x00, 0x00, 0x00, 0x00, 0x00, 0x00, 0x00, 0x00,
0x00, 0x00, 0x00, 0x00, 0x00, 0x00, 0x00, 0x00, 0x00, 0x00,
0x00, 0x00, 0x00, 0x00, 0x00, 0x00, 0x00, 0x00, 0x00, 0x00,
0x00, 0x00, 0x00, 0x00, 0x00, 0x00, 0x00, 0x00, 0x00, 0x00,
0x00, 0x00, 0x00, 0x00, 0x00, 0x00, 0x00, 0x00, 0x00, 0x00,
0x00, 0x00, 0x00, 0x00, 0x00, 0x00, 0x00, 0x00, 0x00, 0x00,
0x00, 0x00, 0x00, 0x00, 0x00, 0x00, 0x00, 0x00, 0x00, 0x00,
0x00, 0x00, 0x00, 0x00, 0x00, 0x00

Besides adjusting the brightness of the image signal, the LCD interface unit 123 can also refer to a configurable two-dimensional reference table to optimize the color of the image signal of each image segment. In general, the reference values in the configurable two-dimensional reference table are the experimental reference values obtained through a lot of subjective evaluations.

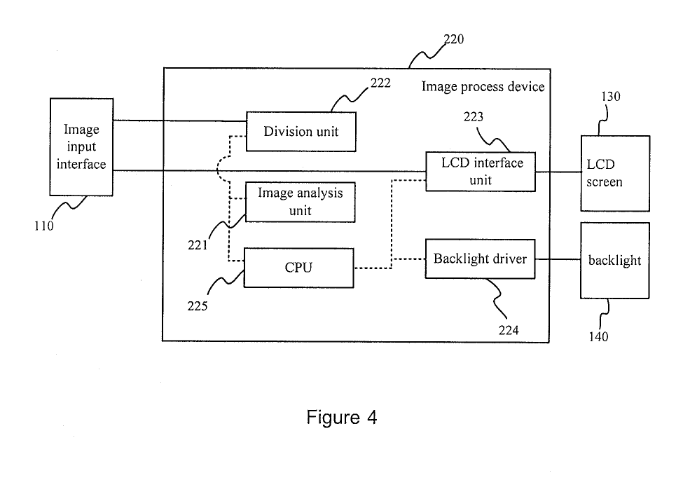

FIG. 4 is a schematic diagram in accordance with the second embodiment applying the LCD method of the present invention. Unlike FIG. 1, the image process device 220 not only comprises image analysis unit 221, LCD interface unit 223, backlight driver 224 and CPU 225, but also comprises a division unit 222.

The image input interface 110 receives image signals and sends them to the image process device 220. The image process device 220 receives the image signals and sends one channel of them to the dividing unit 222. According to certain rules, the image is divided into several different segments. The backlight is also divided into several different segments. The backlight and image may have the same segments. The backlight and image may also have different segments.

The image signal after division is sent to the image analysis unit 221 for analyzing. The image analysis unit 221 calculates the typical brightness of each image segment and sends the calculated typical brightness of each image segment to the CPU 225. Also, the CPU 225 calculates the correction value of the backlight brightness of each segment according to the typical brightness value of each image segment and the backlight brightness of the present segments.

After the correction value of backlight brightness of each present segment is calculated, the CPU 225 will send this correction value of the backlight brightness to the backlight driver 224 and the LCD interface unit 223.

According to the correction value of the backlight brightness of each segment determined by the CPU 225, the backlight driver 224 generates a driving signal corresponding to the correction value of the backlight brightness for the corresponding segment of the backlight 140, thus adjust the backlight brightness of each segment.

Also according to the correction value of the backlight brightness of each segment determined by the CPU 225, the LCD interface unit 223 adjusts the image signal itself, whose process will not be described here.

In other embodiments, the image process device of the LCD device may also comprises a memory to save the result of data processing of each unit in the image process device, therefore, each unit of the image process device can perform the corresponding process through calling the saved data in the memory.

In one embodiment of the invention the correction value of the backlight brightness slowly changes with the variation of the brightness of the image, and the change of the backlight brightness of each time will not surpass the change value of the backlight T. Therefore the change of the brightness of the backlight changes slowly and there are no problems such as the backlight is suddenly being brightened or weakened, Since the change of the brightness of the backlight is slower, there is no sudden, dramatic change in the brightness of the displayed image. This reduces the blinking effect felt by the human eye and improves the perceived visual quality of the display.

The above description is not intended to limit the present invention and the present invention is not limited to the above embodiments. It is evident that various modifications, changes, addition or replacement may be made by those skilled in the area without departing from the spirit and scope of the present invention. Thus, the present invention is intended to embrace all such modifications, changes, addition or replacement as may fall within the scope of the present invention. While an LCD has been used as an example, embodiments of this invention are not limited to use within an LCD and may be applied to any display device that uses a backlight.

What is claimed is:

1. A display method, comprising:
receiving an image signal;
calculating a typical brightness of said image signal;
calculating a brightness correction of the LCD backlight according to the typical brightness of said image signal and a brightness of the LCD backlight;
adjusting the brightness of the LCD backlight according to the brightness correction of the LCD backlight; and
adjusting said image signal.

2. The display method of claim 1, wherein the brightness correction of the backlight is larger than the brightness of the backlight if the typical brightness of said image signal is larger than a predetermined reference value and the brightness correction of the backlight is smaller than the present brightness of the backlight if the typical brightness of the present image signal is smaller than said predetermined reference value.

3. The display method of claim 2, wherein the brightness correction of the backlight is zero if the typical brightness of said image signal is zero.

4. The display method of claim 2, wherein the brightness correction of the backlight is the present backlight brightness plus a predetermined change value if the typical brightness of said image signal is larger than a predetermined reference value and the brightness correction of the backlight is the present backlight brightness minus the predetermined change value if the typical brightness of said image signal is smaller than a predetermined reference value.

5. The display method of claim 2, wherein the predetermined reference value and the change value can be varied according to a user setting.

6. The display method of claim 4, wherein the typical brightness is the weighted average value of the brightness calculated according to the statistical result of the histogram of the brightness of the image.

7. The display method of claim 6, wherein the adjustment for said image signal comprises adjusting the brightness of said image according to the typical brightness of said image.

8. The display method of claim 7, wherein the change value of the brightness of said image is selected according to a curve of the typical brightness of said image.

9. A display method, comprising:
dividing the backlight into at least two backlight segments;
receiving an image signal;
dividing said image into at least two image segments based on the backlight segments;
calculating a typical brightness for each image segment;
calculating a brightness correction of the backlight of each image segment according to the typical brightness of each image segment and the present brightness of the corresponding backlight segments;
adjusting the brightness of each backlight according to the brightness correction of the backlight of each image segment; and
adjusting said image signal.

10. The display method of claim 9, wherein the brightness correction of the backlight of this segment is larger than the present brightness of the backlight of this segment if the typical brightness of said image signal of said image segment is larger than a predetermined reference value and the brightness correction of the backlight of said segment is smaller than the present brightness of the backlight of this segment if the typical brightness of said image signal of this segment is smaller than a predetermined reference value.

11. The display method of claim 10, wherein the brightness correction of the backlight of this segment is zero if the typical brightness of said image signal of this segment is zero.

12. The display method of claim 10, wherein the brightness correction of the backlight of this segment is the present backlight brightness of this segment plus a predetermined change value if the typical brightness of said image signal of this segment is larger than a predetermined reference value and the brightness correction of the backlight of this segment is the present backlight brightness of this segment minus said predetermined change value if the typical brightness of said image signal of this segment is smaller than said predetermined reference value.

13. The display method of claim 12, wherein the predetermined reference value and the change value can be varied according to a user setting, and the predetermined reference and change value of each segment is different.

14. The display method of claim 12, wherein the typical brightness of at least one segment is the weighted average value of the brightness is calculated according to a statistical result of a histogram of the brightness of the image of this segment.

15. The display method of claim 14, wherein the brightness of said image of the at least one segment is adjusted according to the typical brightness of the image of the segment.

16. The display device of claim 15, wherein the change value of the brightness of said image of this segment is selected according to a curve of the typical brightness of said image of this segment.
